(19) United States
(12) Patent Application Publication
(10) Pub. No.: US 2024/0065256 A1
(43) Pub. Date: Feb. 29, 2024

(54) TRAP COVERING DEVICE

(71) Applicant: Denis Tyrrell, Ft. Pierce, FL (US)

(72) Inventor: Denis Tyrrell, Ft. Pierce, FL (US)

(21) Appl. No.: 18/077,601

(22) Filed: Dec. 8, 2022

Related U.S. Application Data
(60) Provisional application No. 63/401,681, filed on Aug. 28, 2022.

(51) Int. Cl. A01M 23/18

(52) U.S. Cl. CPC A01M 23/18

(57) ABSTRACT

A trap covering device, including a main body to be removably disposed on at least a portion of an animal trap, the main body including a first side, a second side disposed away from the first side with respect to a direction to extend away from the first side, a third side disposed away from the first side with respect to the direction to extend away from the first side, and a fourth side disposed away from the first side with respect to the direction to extend away from the first side, such that the main body facilitates access to an interior of the main body through an open end in a space between the first side, the second side, the third side, and the fourth side while the animal trap is on a ground surface, and a trap access aperture disposed on at least a portion of the first side to facilitate access to a hatch door of the animal trap.

### CROSS-REFERENCE TO RELATED APPLICATIONS

This application claims priority under 35 USC § 120 from U.S. Provisional Application No. 63/401,681, entitled “Trap Covering Device,” which was filed on Aug. 28, 2022, in the United States Patent and Trademark Office, the disclosure of which is incorporated herein in its entirety by reference.

### BACKGROUND

### 1. Field

The present general inventive concept relates generally to animal traps, and particularly, to a trap covering device.

### 2. Description of the Related Art

People and animals often cross paths where the animals are considered a pest. Pest situations often arise where animals, such as rodents, compete for food and can cause damage to crops and/or interfere with other animals.

In response to these problems, people may employ the use of animal traps to catch the animals and remove them from the problem area. However, some animals may adapt to existing traps and create ways to retrieve the food without being caught and/or trigger the trap safely and retrieve the food without entering the animal trap. These clever strategies make the animal trap ineffective and cause a toll on people impacted by such pests.

Therefore, there is a need for a trap covering device to cover the animal trap and prevent the animal from circumventing a trap trigger.

### SUMMARY

The present general inventive concept provides a trap covering device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a trap covering device, including a main body to be removably disposed on at least a portion of an animal trap, the main body including a first side, a second side disposed away from the first side with respect to a direction to extend away from the first side, a third side disposed away from the first side with respect to the direction to extend away from the first side, and a fourth side disposed away from the first side with respect to the direction to extend away from the first side, such that the main body facilitates access to an interior of the main body through an open end in a space between the first side, the second side, the third side, and the fourth side while the animal trap is on a ground surface, and a trap access aperture disposed on at least a portion of the first side to facilitate access to a hatch door of the animal trap.

The trap access aperture may be lined with at least one of a gel and cloth to prevent injury during use.

The trap covering device may further include an animal attracting scent disposed on at least a portion of the main body to attract at least one type of animal.

The animal attracting scent may be infused into a construction of the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front side perspective view of a trap covering device as disposed over a trap, according to an exemplary embodiment of the present general inventive concept;

FIG. 2 illustrates a rear side perspective view of the trap covering device as disposed over the trap, according to an exemplary embodiment of the present general inventive concept; and

FIG. 3 illustrates an exploded view of the trap covering device and the trap, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Trap Covering Device 100
Main Body 110
First Side 111
Second Side 112
Third Side 113
Fourth Side 114
Trap Access Aperture 120
Animal Attracting Scent 130

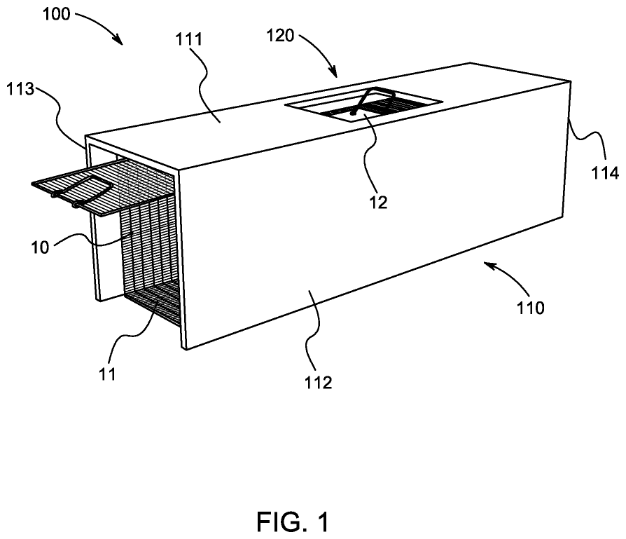

FIG. 1 illustrates a front side perspective view of a trap covering device 100 as disposed over a trap 10, according to an exemplary embodiment of the present general inventive concept.

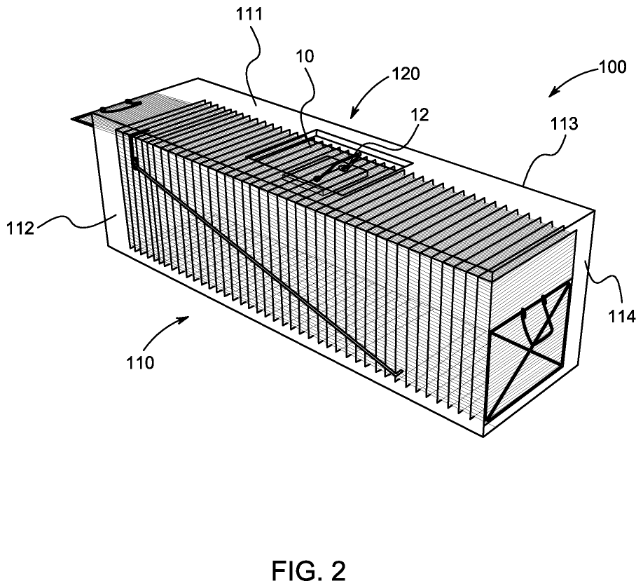

FIG. 2 illustrates a rear side perspective view of the trap covering device 100 as disposed over the trap 10, according to an exemplary embodiment of the present general inventive concept.

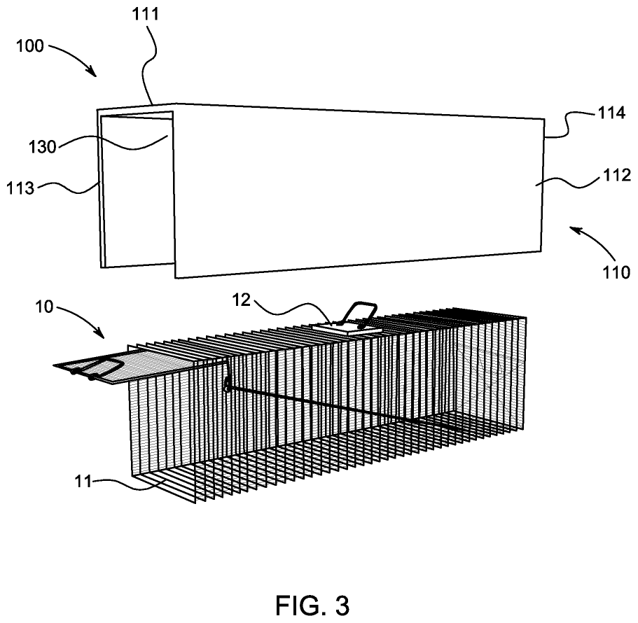

FIG. 3 illustrates an exploded view of the trap covering device 100 and the trap 10, according to an exemplary embodiment of the present general inventive concept.

The trap covering device 100 may be constructed from at least one of wood, metal, plastic, and rubber, etc., but is not limited thereto.

Referring to FIGS. 1 through 3, the trap covering device 100 may include a main body 110, a trap access aperture 120, and an animal attracting scent 130, but is not limited thereto.

Referring again to FIGS. 1 through 3, the main body 110 is illustrated to have a rectangular prism shape. However, the main body 110 may be rectangular, circular, conical, triangular, pentagonal, hexagonal, heptagonal, octagonal, or any other shape known to one of ordinary skill in the art, but is not limited thereto.

The main body 110 may include a first side 111, a second side 112, a third side 113, and a fourth side 114, but is not limited thereto.

The main body 110 may be removably disposed on and/or over at least a portion of an animal trap 10. The main body 110 may cover at least a portion of the animal trap 10.

The first side 111 may be a top surface.

The second side 112 may be angularly (e.g., perpendicularly) disposed away from a first side and/or a first edge of the first side 111 with respect to a direction. The second side 112 may extend away from the first side 111 at a predetermined height. For example, the second side 112 may extend away from the first side 111 corresponding to a distance greater than a height of the animal trap 10.

The third side 113 may be angularly (e.g., perpendicularly) disposed away from a second side and/or a second edge of the first side 111 with respect to the direction. The third side 113 may extend away from the first side 111 at the predetermined height, such that the third side 113 may have a size (e.g., height, length, width) equivalent to a size (e.g., height, length, width) of the second side 112. For example, the third side 113 may extend away from the first side 111 corresponding to a distance greater than the height of the animal trap 10.

The fourth side 114 may be angularly (e.g., perpendicularly) disposed away from a third side and/or a third edge of the first side 111 with respect to the direction. The fourth side 114 may extend away from the first side 111 at the predetermined height, such that the fourth side 114 may have a size (e.g., height, length, width) equivalent to the size of the second side 112 and/or the third side 113. Alternatively, the size of the fourth side 114 may be less than the size of the second side 112 and/or the third side 113. For example, the fourth side 114 may extend away from the first side 111 corresponding to a distance greater than the height of the animal trap 10.

Thus, the first side 111, the second side 112, the third side 113, and/or the fourth side 114 may surround the animal trap 10. However, a bottom portion of the main body 110 disposed opposite with respect to the first side 111 and an open end disposed opposite with respect to the fourth side 114 may be open and facilitate access to an interior of the main body 110 through the open end in a space between the first side 111, the second side 112, the third side 113, and/or the fourth side 114. In other words, the main body 110 may lack a fifth side and/or a sixth side, such that the main body 110 may not be enclosed. As such, the main body 110 may receive and/or surround the animal trap 10 therein while the animal trap 10 is disposed on an external surface, such as a ground surface, a table, and/or a countertop.

Furthermore, the main body 110 may facilitate access to the animal trap 10 through the open end while the main body 110 covers the animal trap 10. As such, the main body 110 may prevent access to the animal trap 10 through the first side 111, the second side 112, the third side 113, and/or the fourth side 114. Accordingly, the main body 110 may force an animal to enter an entrance 11 of the animal trap 10 through the open end only, such that the animal may be prevented from snatching bait (e.g., food) inside the animal trap 10 without entering the entrance 11 of the animal trap 10 and/or prematurely triggering the animal trap 10 without entering.

The trap access aperture 120 may be disposed on at least a portion of the first side 111. The trap access aperture 120 may facilitate access to a hatch door 12 of the animal trap 10. The trap access aperture 120 may be lined with a gel and/or cloth to provide a smooth surface and prevent injury during use.

The animal attracting scent 130 may include at least one animal pheromone, at least one fragrance, at least one food scented substrate, and/or any combination thereof, but is not limited thereto.

The animal attracting scent 130 may be disposed on at least a portion of the main body 110. Alternatively, the animal attracting scent 130 may be infused into the construction of the main body 110. For example, the animal attracting scent 130 may be infused into a wooden construction of the main body 110. Additionally, the animal attracting scent 130 may be specifically manufactured to attract at least one type of animal, such as rodents, insects, raccoons, etc.

Therefore, the trap covering device 100 may cover the animal trap 10 and/or prevent access from a plurality of sides of the animal trap 10. As such, the trap covering device 100 may direct the animal to enter the animal trap 10 through the entrance 11, such that the animal may be trapped while retrieving any bait therein.

The present general inventive concept may include a trap covering device 100, including a main body 110 to be removably disposed on at least a portion of an animal trap 10, the main body 110 including a first side 111, a second side 112 disposed away from the first side 111 with respect to a direction to extend away from the first side 111, a third side 113 disposed away from the first side 111 with respect to the direction to extend away from the first side 111, and a fourth side 114 disposed away from the first side 111 with respect to the direction to extend away from the first side 111, such that the main body 110 facilitates access to an interior of the main body 110 through an open end in a space between the first side 111, the second side 112, the third side 113, and the fourth side 114 while the animal trap 10 is on a ground surface, and a trap access aperture 120 disposed on at least a portion of the first side 111 to facilitate access to a hatch door 12 of the animal trap 10.

The trap access aperture 120 may be lined with at least one of a gel and cloth to prevent injury during use.

The trap covering device 100 may further include an animal attracting scent 130 disposed on at least a portion of the main body 110 to attract at least one type of animal.

The animal attracting scent 130 may be infused into a construction of the main body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A trap covering device, comprising:
a main body to be removably disposed on at least a portion of an animal trap, the main body comprising:
a first side,
a second side disposed away from the first side with respect to a direction to extend away from the first side,
a third side disposed away from the first side with respect to the direction to extend away from the first side, and
a fourth side disposed away from the first side with respect to the direction to extend away from the first side, such that the main body facilitates access to an interior of the main body through an open end in a space between the first side, the second side, the third side, and the fourth side while the animal trap is on a ground surface; and
a trap access aperture disposed on at least a portion of the first side to facilitate access to a hatch door of the animal trap.

2. The trap covering device of claim 1, wherein the trap access aperture is lined with at least one of a gel and cloth to prevent injury during use.

3. The trap covering device of claim 1, further comprising:
an animal attracting scent disposed on at least a portion of the main body to attract at least one type of animal.

4. The trap covering device of claim 3, wherein the animal attracting scent is infused into a construction of the main body.
